(19) United States
(12) Patent Application Publication
(10) Pub. No.: US 2007/0181623 A1
(43) Pub. Date: Aug. 9, 2007

(54) Storage component system

(76) Inventor: Allen P Schneider, Oakdale, MN (US)

Correspondence Address: Richard John Bartz, 6750 France Avenue South, Suite 350, Edina, MN, 55435, US

(21) Appl. No.: 11/702,392

(22) Filed: Feb. 5, 2007

Related U.S. Application Data
(60) Provisional application No. 60/765,434, filed on Feb. 6, 2006.

(51) Int. Cl. B60R 7/00; B60R 9/00

(52) U.S. Cl. 224/401; 296/37.1

(57) ABSTRACT

A storage device utilizes the interior cavity of the front storage box of an all-terrain vehicle. The device has dual containers which incorporate the box dimensions and features. The box lid when closed securely holds the containers in the cavity. The containers are configured to hold liquids, such as fuel, or items such as tool kits, first aid kits, and the like.

### CROSS REFERENCE TO RELATED APPLICATION

This application claims the priority of U.S. application Ser. No. 60/765,434 filed Feb. 6, 2006.

### FIELD OF THE INVENTION

The invention is directed to a storage device designed to utilize the interior cavities of recreational vehicles, such as all-terrain vehicles, snowmobiles, utility vehicles and personal watercraft

### BACKGROUND OF THE INVENTION

All-terrain vehicle (ATV) riders have various items that need to be carried with them while on the trail. These items can include extra clothing, repair kits, food, bait, spare fuel or water, etc. Generally the standard storage box or bag designed for the storage and transportation of these items are generally mounted on the cargo racks, tank or fenders and consume the entire rack. This leaves virtually no room for other items that one may want to keep separate. And the opposite is true when items are stored on the cargo racks, leaving minimal room for storage containers. Again, this can be a problem because a rider may not want to store all items together. For example, one wouldn't carry spare fuel with other items such as clothing or food.

Securing loose items to cargo racks can be difficult. These items need to be strapped in place by a conglomeration of bungee straps, ropes or nets. Consequently, they can be difficult to secure, especially when driving off-road. When one item is removed, the remaining items need to be reorganized, repositioned and re-secured. Often, it is difficult or impossible to reproduce the same technique to secure the load. Standard fuel containers can be especially difficult to secure and can be easily knocked off the vehicle entirely during transportation.

Some ATV's have storage compartments to hold loose items. In this case, items end up haphazardly strewn about in a loose, unorganized and inefficient mess within the storage compartment. When riding off road, these items bounce around and can even cause damage.

### SUMMARY OF THE INVENTION

The storage container system of the invention is removable, functional and designed to utilize, expand and enhance the versatility of the storage cavities of a recreational vehicle, such as the storage compartment of an all-terrain vehicle, snowmobile, utility vehicle, personal watercraft and the like. The container system provides a convenient, efficient and secure method of storing and transporting liquids and non-liquid items. The overall shape and size of the container system is substantially the same as the shape and size of the vehicle storage cavity.

The container system has a liquid storage container that facilitates the storage and transfer of liquids, such as fuel, water and bait suspended in water. The container system is also used to hold and store non-liquid items. The non-liquid container can hold general items or can be configured to hold specific items including, but not limited to, a tire repair kit, general tool kit, survival kit and first aid kit. Both the liquid and non-liquid storage containers can be used in conjunction with each other and fit into the front storage compartment of an all-terrain vehicle.

### DESCRIPTION OF THE DRAWINGS

FIG. 1 is an elevated perspective view of the storage container system of the invention installed in the front storage compartment of an all-terrain vehicle;

FIG. 2 is an exploded elevated perspective view of the container system placement of FIG. 1;

FIG. 3 is an enlarged perspective view of the liquid storage container of the system of FIG. 1;

FIG. 4 is an elevated side view of the container of FIG. 3;

FIG. 5 is a top plan view of the container of FIG. 3;

FIG. 6 is a bottom plan view of the container of FIG. 3;

FIG. 7 is an elevated end view of the left end of the container of FIG. 3;

FIG. 8 is an elevated end view of the right end of the container of FIG. 3;

FIG. 9 is an exploded perspective view of the container of FIG. 3;

FIG. 10 is an enlarged foreshortened sectional view of the liquid storage container placed in the front storage compartment of an all-terrain vehicle taken along line 10-10 of FIG. 1;

FIG. 11 is an enlarged perspective view of a non-liquid storage container of the system of FIG. 1;

FIG. 12 is an elevated side view of the left side of the container of FIG. 11;

FIG. 13 is an elevated side view of the right side of the container of FIG. 11;

FIG. 14 is a top plan view of the container of FIG. 11;

FIG. 15 is an elevated end view of the left end of the container of FIG. 11;

FIG. 16 is an elevated end view of the right end of the container of FIG. 11; and

FIG. 17 is an exploded perspective view of the container of FIG. 11 with the lid open showing the removable tray.

### DESCRIPTION OF PREFERRED EMBODIMENT

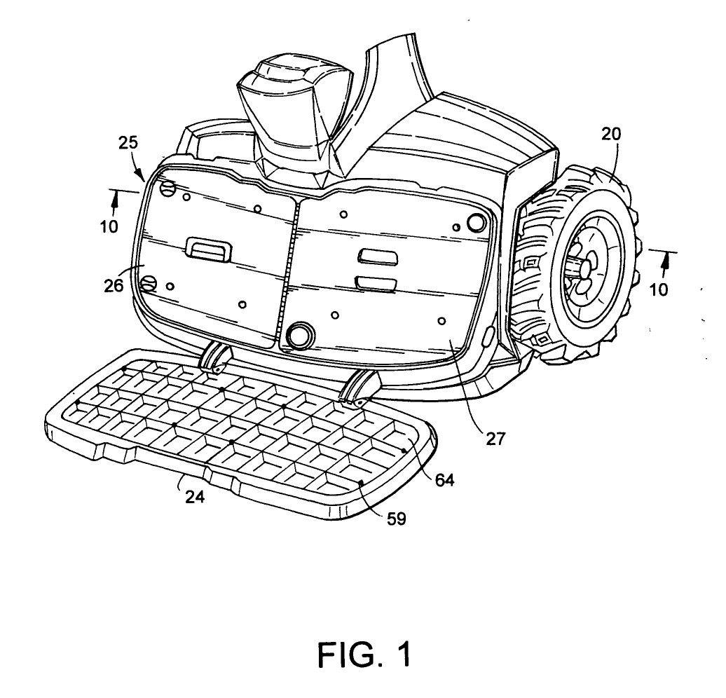

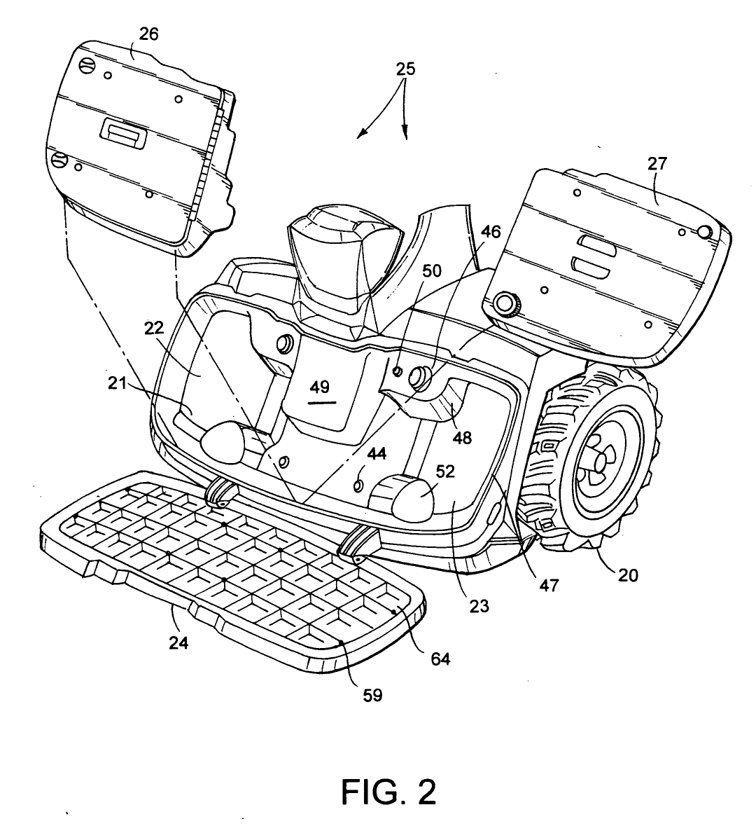

Referring to FIGS. 1 and 2, there is shown a storage container system of the invention indicated generally at 25. Container system 25 facilitates the storage and transfer of liquids, such as fuel, water and bait, as well as non-liquid items, such as kits, food and clothing, in a convenient, efficient and secure method. Container system 25 has dual containers 26 and 27 that securely fits into the interior space of the enclosed front storage compartment 21 of an all-terrain vehicle 20. Container system 25 can also be adapted to fit into and utilize the interior areas of storage compartments of other types of recreational vehicles, such as snowmobiles, utility vehicles, personal watercraft and the like. Storage container system 25 has a first right hand or right side non-liquid storage container 26 and a second left hand or left side liquid storage container 27. Container 26 fits into the right side cavity 22 of compartment 21. In similar manner container 27 fits into the left side cavity 23 of compartment 21 adjacent container 26 in side-by-side relation. Containers 26 and 27 substantially fill the overall storage area of compartment 21. A lid 24 closing compartment 21 engages the tops of containers 26 and 27 to retain containers 26 and 27 in compartment 21. Containers 26 and 27 may be both liquid storage containers or both non-liquid storage containers, if desired.

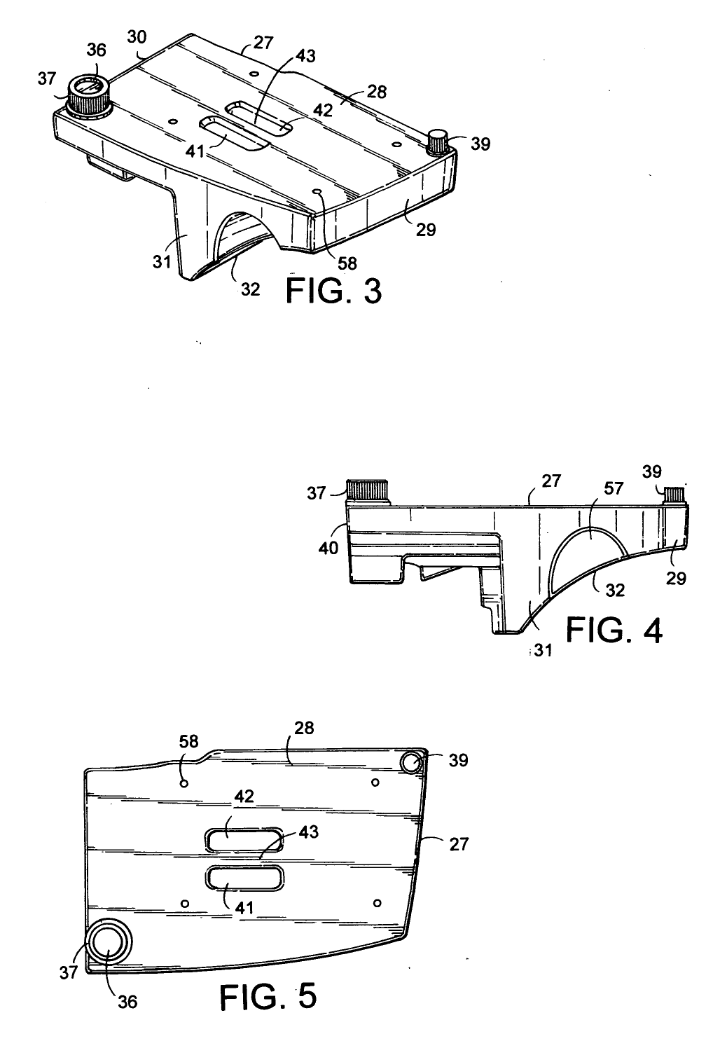

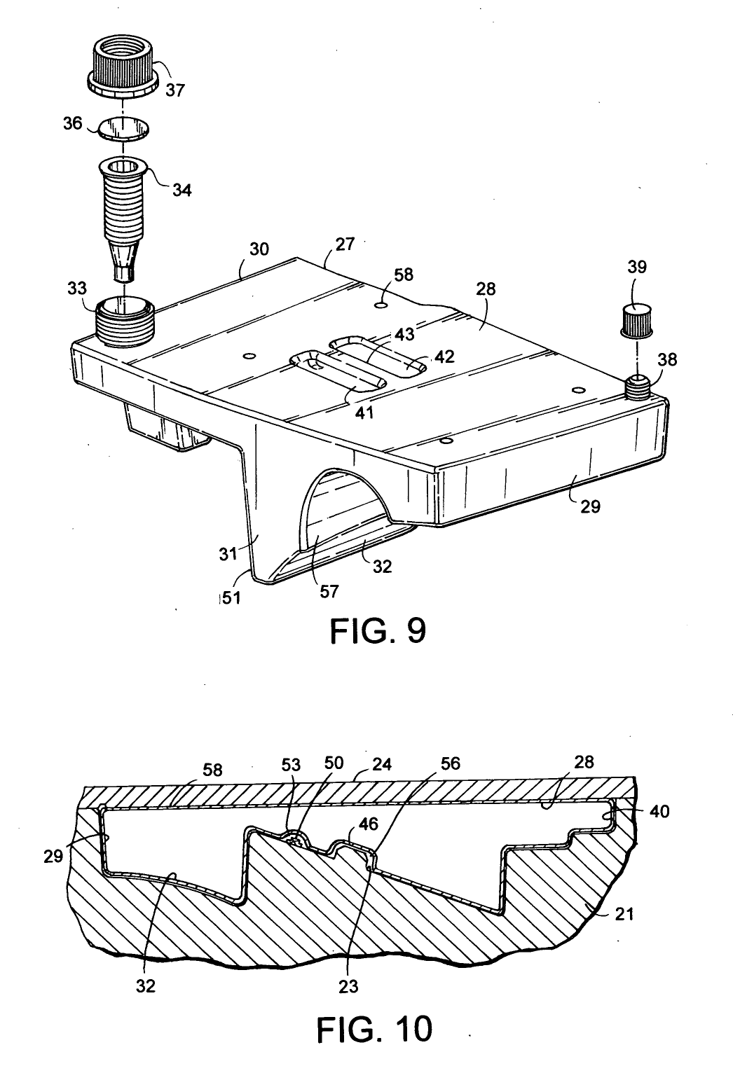

As shown in FIGS. 3 to 9, liquid storage container 27 has a generally rectangular body 30 with a generally flat top wall 28 joined to downwardly directed end walls 29 and 35 and side walls 31 and 40. End wall 29 has a slight convex curved shape to substantially match the concurve shape of compartment wall 47. As seen in FIG. 7, end wall 35 has a downwardly directed protrusion 45 that extends to the bottom of cavity to stabilize container 27 in compartment 21. Side wall 31 extends between end walls 29 and 35 and has a downwardly directed middle portion 51 joined to a relatively flat bottom end 63. End 63 engages the bottom of cavity 23 when container 27 is placed in cavity 23 for further stability.

Container 27 has a contoured, curving bottom wall 32 connected to the side and end walls 29, 31, 35 and 40 generally opposite top wall 28. One corner of top wall 28 has a threaded opening 33 for filling and removal of liquids, such as fuel, water containing bait and drinking water, into and out of container 27. A filler nozzle 34 located in opening 33 is removable to assist pouring liquid from container 27. Washer 36 and a cap 37 threaded on opening 33 seal opening 33. The opposite corner of top wall 28 has a small threaded opening 38 to vent container 27 during the filling and liquid removal process. A cap 39 threaded oil opening 38 seals opening 38. Openings 33 and 38 extend into the grid recesses 64 in the bottom of lid 24 whereby openings 33 and 38 do not engage the bottom of lid 24 when lid 24 is closed. Top wall 28 has a centrally located recess having a pair of openings 41 and 42 open to top wall 28 to define a handle 43 to facilitate placement and removal of container 27 from cavity 23. Preferably, handle 43 is molded into the middle of top wall 28. Other types of handles can be used with container 27.

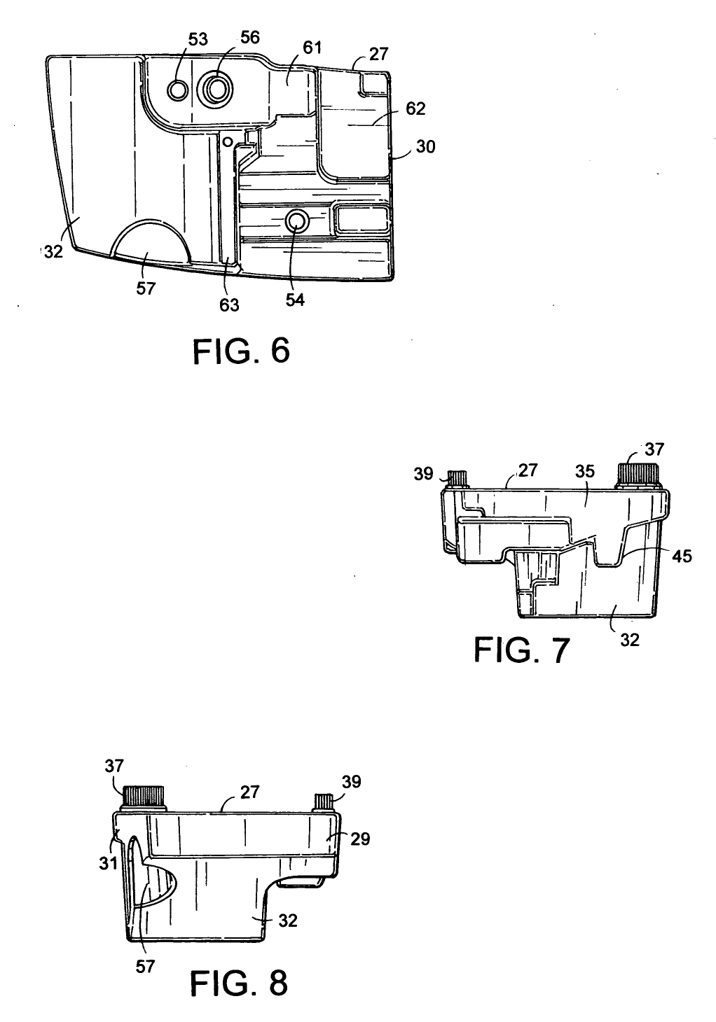

Bottom wall 32 is contoured to fit the overall shape and contour of the bottom of cavity 23. Bottom wall 32 has substantially the same dimensions and tolerances of cavity 23 and accommodates the features of vehicle 20 extending into cavity 23, such as bolts 44, 46 and 50, shock housing 48, head lamp housing 52. As seen in FIG. 6, bottom wall 32 has inwardly directed circular cavities 53 and 54 for accommodating bolts 44 and 50 when container 27 is placed in cavity 23. A larger generally circular cavity 56 extending into bottom wall 32 accommodates shock bolt 46. Concave recess 57 open to side wall 31 receives head light housing 52 in the front portion of cavity 23. Shock housing 48 and drive housing 49 fit into complimentary shaped recesses 61 and 62 in bottom wall 32.

Container 27 is retained within cavity 23 by lid 24 when lid 24 is closed and latched to vehicle 20 to close compartment 21. Recesses 58 in top wall 28 of container 27 accommodate bolts 59 extending outwardly from the bottom of lid 24 when lid 24 is in the closed position whereby the bottom of lid 24 engages top wall 28. As seen in FIG. 10, side walls 29 and 40 and bottom wall 32 of body 30 fit the contour of the bottom and sides of cavity 23 whereby container 27 substantially fills and fits within the overall interior cavity 23 of front storage compartment 21 of vehicle 20.

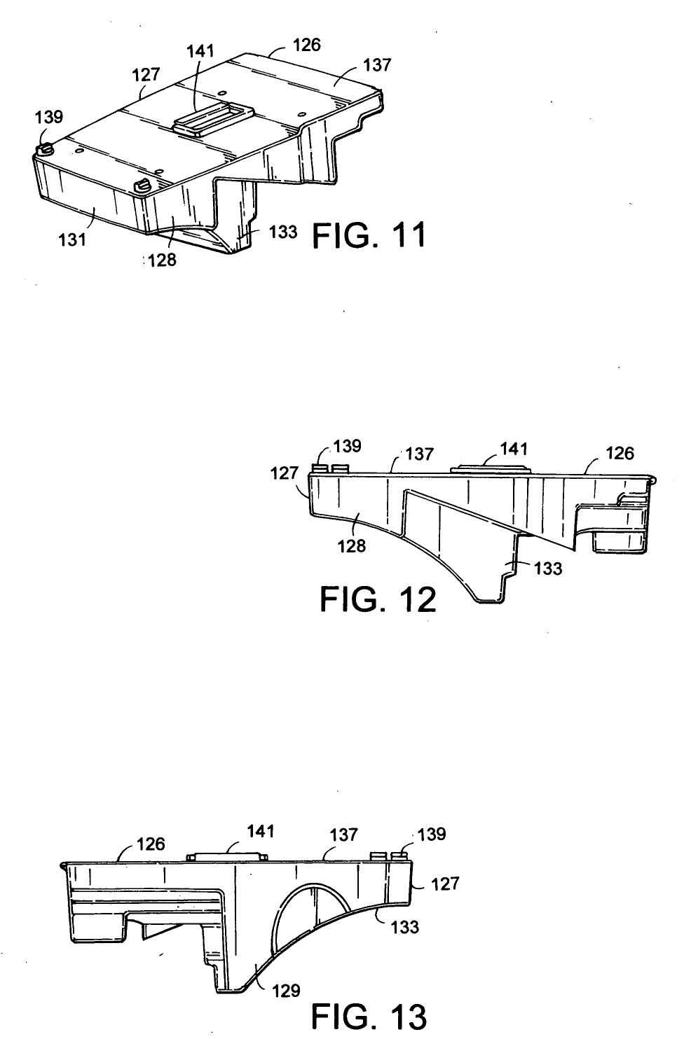

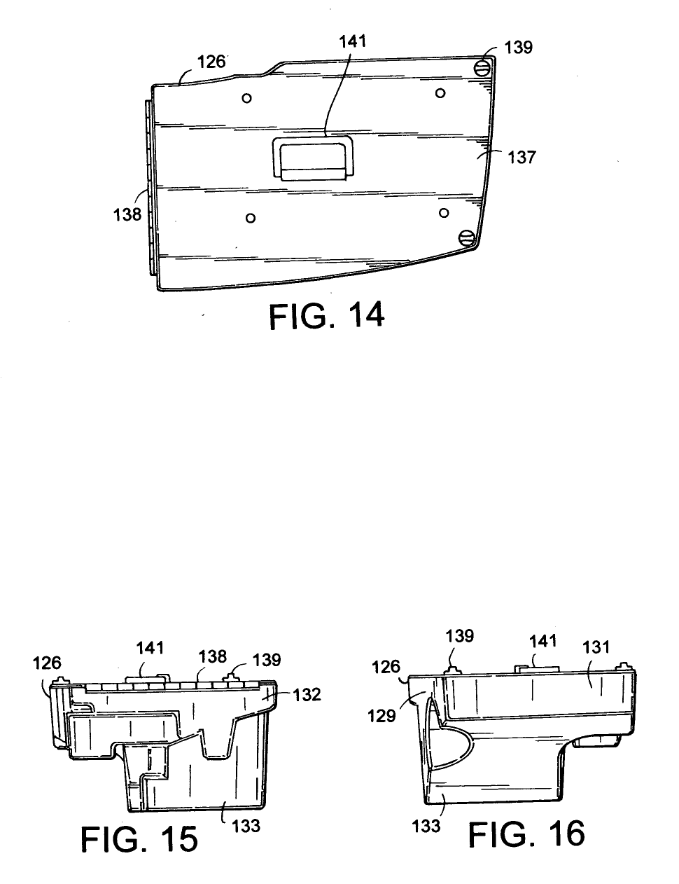

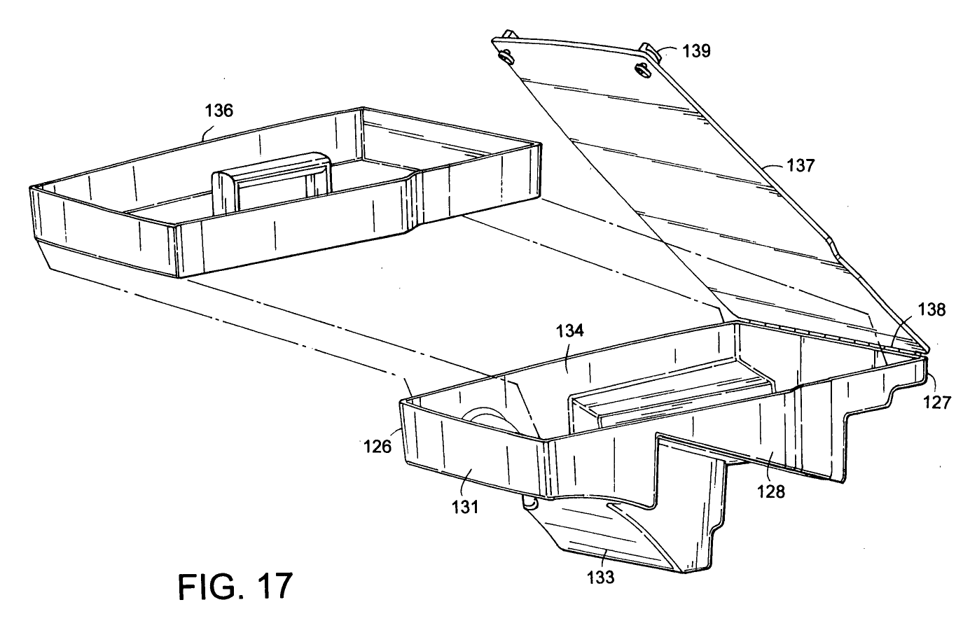

Referring to FIGS. 11 to 17 there is shown a first modification of the storage container, indicated at 126, useable with storage container system 25. Container 126 is interchangeable with liquid storage container 27 of storage container system 25. Storage container 126 is a non-liquid storage container adapted to hold non-liquid items such as tire repair, tool, survival and first aid kits, food, clothing and the like. Container 126 fits into the left side cavity 23 of compartment 21. Container 126 is a mirror image of container 26 located in cavity 22. Container 126 can be simultaneously used with container 26 whereby both containers of storage container system 25 would be non-liquid storage containers. Container 126 has a size and shape substantially the same as the size and shape of cavity 23 whereby container 126 fits securely into cavity 23. When lid 24 is closed and latched to vehicle 20, the bottom of lid 24 is located adjacent to the cover 137 of container 126 to hold container 126 in cavity 23 in a tight fitting manner.

Container 126 has a generally rectangular shaped body 127 having generally upright side walls 128 and 129 and end walls 131 and 132 joined to a contoured curving bottom wall 133. The interior 134 of container body 127 accommodates a removable generally rectangular tray 136 adapted to hold tools, gear, tackle and the like, as desired. The top of container 126 is closed with a cover or lid 137 pivotally connected to the top of end wall 132 with a hinge 138. Latches 139 on the top of lid 137 are operable to hold lid 137 in a closed position on container 136. A handle 141 connected to lid 137 facilitates placement and removal of container 126 from cavity 23 of storage compartment 21. When latches 139 are turned and unhooked, lid 137 can be opened without removing container 126 from cavity 23. Lid 137 pivots upwardly away from end wall 131 toward the middle of compartment 21. Side walls 128 and 129, end walls 131 and 132, and bottom wall 133 have substantially the same dimensions, size and shape as side walls 31 and 40, end walls 29 and 35, and bottom wall 32 of container 27 and are complementary in shape and contoured to substantially match and fit the shape and contour of cavity 23 so as to store and transport non-liquid items in an efficient and secure manner.

In use, non-liquid container 26 and liquid container 27 are both stowed in side-by-side relation in compartment 21 distinctly separate from each other thereby leaving the vehicle cargo racks free for other uses. Containers 26 and 27 are easily removed from compartment 21 and replaced with containers of substantially the same shape and contour configured for different uses. For example, a hunter could carry a container configured as a survival kit and another container filled with water. The containers can be quickly and easily replaced with a container configured as a tire repair kit and one suitable for fuel storage for long trail rides. Further, the containers themselves provide convenient storage in the off season.

The present disclosure are preferred embodiments of the storage container system. It is understood that the storage container system is not to be limited to the specific materials, constructions, arrangements and method of operation shown and described. It is understood that changes in parts, materials, arrangement and locations of structures may be made without departing from the invention.

1. A container storage system for a recreational vehicle having an interior compartment closed with a lid for storing and transporting liquids and items comprising: one or more containers having an enclosed chamber, the container having generally upright side walls and end walls joined to a bottom wall to define the chamber, the container having substantially the same overall size and shape of the interior compartment whereby when the lid is closed to close the compartment, the container is secured inside the compartment, the bottom wall having a shape and contour complementary to the shape and contour of the bottom of the compartment.

2. The storage system of claim 1 including: handle means attached to the top wall of the container.

3. The storage system of claim 1 including: first and second containers, the containers substantially filling the compartment.

4. The storage system of claim 1 wherein: the container is a liquid storage container having a first opening for filling and removal of liquid, a first cap closing the first opening, a second opening for venting the container, and a second cap closing the second opening.

5. In combination, an all-terrain vehicle, the vehicle having a front storage compartment, a lid closing the compartment, the compartment having one or more interior cavities, at least one container adapted to fit into the compartment, the container fitting the overall shape and size of one of the cavities, and handle means attached to the container to facilitate placement and removal from the cavity, the lid holding the container in the cavity with the lid closes the compartment.

6. The combination of claim 5 including: a second container located in the compartment adjacent the first container, the first and second containers substantially filling the compartment.

7. The combination of claim 6 wherein: the first and second containers are containers adapted for storing and transporting liquids.

8. The combination of claim 6 wherein: the first and second containers are containers adapted for storing and transporting non-liquid items.

9. The combination of claim 6 wherein: the first container is a liquid storage container, the second container being a non-liquid storage container.

10. The combination of claim 5 wherein: the container is a container for non-liquid items, the container having a tray, a lid pivotally connected with hinge means to the top of the container, and fasteners releasably securing the lid to the container, the lid adapted to be pivoted to an open position without removing the container from the compartment.

11. The combination of claim 10 wherein: the hinge means is located on the end of the container adjacent the middle of the compartment whereby the lid is pivoted toward the middle of the compartment when the lid is moved to the open position.

12. The combination of claim 5 wherein: the container is a liquid storage container having a top wall, bottom wall, side walls and ends walls joined to a top wall to define an enclosed chamber, an opening in the top wall, and a cap closing the opening.

13. The combination of claim 12 wherein: the top wall engages the lid to hold the container in the cavity.

14. The combination of claim 12 wherein: the bottom wall has a shape and size substantially complementary to the shape and size of the bottom of the cavity.

15. The combination of claim 12 including: handle means molded into the top wall of the container to facilitate placement and removal of the container from the cavity.

16. The combination of claim 5 wherein: the container has generally upright side walls and end walls joined to a bottom wall, a cover pivotally connected to one of the end walls closing the top of the container, latch means mounted on the cover operable to releasably hold cover in a closed position on the container.

17. A method of storing and transporting liquids and non-liquid items in one or more containers in an enclosed storage compartment of a recreational vehicle, comprising: locating at least one of the containers in the compartment, the container having a shape and size substantially the same as the overall shape and size of the compartment, and closing the compartment with a lid thereby securing the container in the compartment.

18. The method of claim 17 including: containing a first material in a first container, containing non-liquid items in a second container, locating the first container adjacent the second container in side-by-side relation in the compartment whereby the compartment is substantially filled with the first and second containers.
